(19) United States
(12) Patent Application Publication
(10) Pub. No.: US 2014/0351030 A1
(43) Pub. Date: Nov. 27, 2014

(54) Electronic Distribution and Management of Transactional Promotional Campaigns

(71) Applicant: Seth Priebatsch, Boston, MA (US)

(72) Inventor: Seth Priebatsch, Boston, MA (US)

(21) Appl. No.: 13/901,352

(22) Filed: May 23, 2013

(51) Int. Cl. G06Q 30/02

(52) U.S. Cl. CPC G06Q 30/0211
USPC 705/14.13

(57) ABSTRACT

Systems and methods for distributing and tracking a promotional offer that is electronically claimable and redeemable by consumers determine a predicted fill rate, and compare the predicted fill rate to a target fill rate to dynamically adjust distribution and availability of the offer.

### BACKGROUND

Merchants and suppliers often use promotional campaigns when marketing their products, providing consumers or business customers with discounts or other incentives to purchase goods or services. Promotional campaigns include coupons, price reductions, buy-one-get-one-free promotions, and other promotional offers. The objective of the promotional campaign is to induce consumers to try or purchase products. Currently, the most prevalent method of distributing the promotional offers is electronic—offering the promotion to consumers through a variety of portals (e.g., social media applications, email, blogs, mobile applications, and the like). If consumers re-share the offer, the effect can be “viral” and reach an even wider variety of consumers.

While electronic promotional campaigns are effective at reaching a diverse group of consumers for promoting brand recognition, they can lead to an oversaturation of available discounts that may actually lower the value of the merchant's product or brand. Additionally, the merchant may only have a limited budget available to cover the promotion itself and the lower margins incurred due to the discounted price. Accordingly, merchants may wish to targeting a maximum number of actual redemptions; the problem is that the number of consumers who claim the promotion inevitably exceeds the number of actual redemptions (the “fill rate”), and the fill rate generally cannot be predicted with any degree of accuracy, given the number of factors that influence possible consumer response. Today, merchants tend to simply guess, risking an unsuccessful campaign or one that is too successful to be profitable.

### SUMMARY

The present approach provides the merchant with control over an electronic promotion by facilitating dynamic changes to the distribution of the promotion based on real-time monitoring of redemptions. This allows the merchant to adjust distribution and availability of the offer on an ongoing basis, while the promotion is in effect, to accurately obtain the desired fill rate.

Accordingly, in one aspect, the invention pertains to a computer-implemented method of operating a promotional campaign to dynamically target a specific fill rate. In representative embodiments, the method includes electronically distributing to a first group of consumers a promotional offer claimable and redeemable via an electronic device; tracking claims and redemptions of the offer by the consumers; computationally determining a current predicted fill rate based at least in part on the tracking, the fill rate corresponding to a number of redemptions of the offer; and electronically distributing the promotional offer to a second group of consumers if the current predicted fill rate is less than the target fill rate. The current predicted fill rate may be determined based at least in part on an elapsed time since initiation of the campaign.

In various embodiments, the predicted fill rate is based at least in part on the ratio of claimed offers to redeemed offers and a reference ratio of claimed offers to redeemed offers. Alternatively, or in addition, the predicted fill rate may be based at least in part on calculated likelihoods of redemption of the claimed offers. The likelihood of redemption, in turn, may be based at least in part on the amount of time that has elapsed since the consumer has claimed the promotional offer. Additionally, the method may further comprise sending reminders to consumers who claimed the promotional offer, in which case calculating the likelihoods of redemption can be based at least in part on the number of reminders that have been sent. Alternatively, or in addition, the predicted fill rate may be based at least in part on the viral spread of the offer. The offer may be trackably sharable and the viral spread may be based at least in part on tracked sharing of the offer.

In another aspect, the invention relates to a system for managing a promotional campaign to dynamically target a specific fill rate. In various embodiments, the system includes a promotions database for storing records each comprising (i) an identifier of a consumer to whom the offer has been sent and (ii) a status field indicating whether the consumer has claimed or redeemed the promotional offer, and a processor for executing (i) a tracking module for updating the promotions database each time a consumer claims the promotional offer and for updating the promotions database each time a consumer redeems the promotional offer; (ii) a prediction module for calculating the predicted fill rate based at least in part on the data in the promotions database, the fill rate corresponding to a number of redemptions of the offer; and (iii) a distribution module for distributing the promotional offer to consumers based at least in part on the predicted fill rate.

In various embodiments, the predicted fill rate is based at least in part on the ratio of claimed offers to redeemed offers and a reference ratio of claimed offers to redeemed offers. Alternatively, or in addition, the predicted fill rate may be based at least in part on calculated likelihoods of redemption of the claimed offers. The likelihood of redemption, in turn, may be based at least in part on the amount of time that has elapsed since the consumer has claimed the promotional offer. Additionally, the distribution module may be further configured to send reminders to consumers who claimed the promotional offer and the prediction module may be configured to calculate the likelihoods of redemption based at least in part on a number of reminders that have been sent. Alternatively, or in addition, the prediction module may be configured to compute the viral spread of the offer.

As used herein, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. In addition, the terms like “consumer equipment,” “mobile station,” “mobile,” “communication device,” “access terminal,” “terminal,” “handset,” and similar terminology, refer to a wireless device (e.g., cellular phone, smart phone, computer, PDA, set-top box, Internet Protocol Television (IPTV), electronic gaming device, printer, and so forth) utilized by a consumer of a wireless communication service to receive or convey data, control, voice, video, sound, gaming, or substantially any data-stream or signaling-stream. The foregoing terms are utilized interchangeably in the subject specification and related drawings. The terms “component,” “system,” “platform,” “module,” and the like refer broadly to a computer-related entity or an entity related to an operational machine with one or more specific functionalities. Such entities can be hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

### BRIEF DESCRIPTION OF THE DRAWINGS

In the drawings, like reference characters generally refer to the same parts throughout the different views. Also, the drawings are not necessarily to scale, with an emphasis instead generally being placed upon illustrating the principles of the invention. In the following description, various embodiments of the present invention are described with reference to the following drawings, in which:

FIG. 1 is a block diagram of an exemplary network in accordance with an embodiment of the invention;

FIGS. 2A, 2B, and 2C are block diagrams of an exemplary consumer device, campaign processor, and merchant system respectively, in accordance with an embodiment of the invention;

FIG. 3 conceptually illustrates a promotional offer in accordance with an embodiment of the invention; and

FIG. 4 depicts a method for organizing an electronic promotional campaign to target a specific fill rate in accordance with an embodiment of the invention.

### DETAILED DESCRIPTION

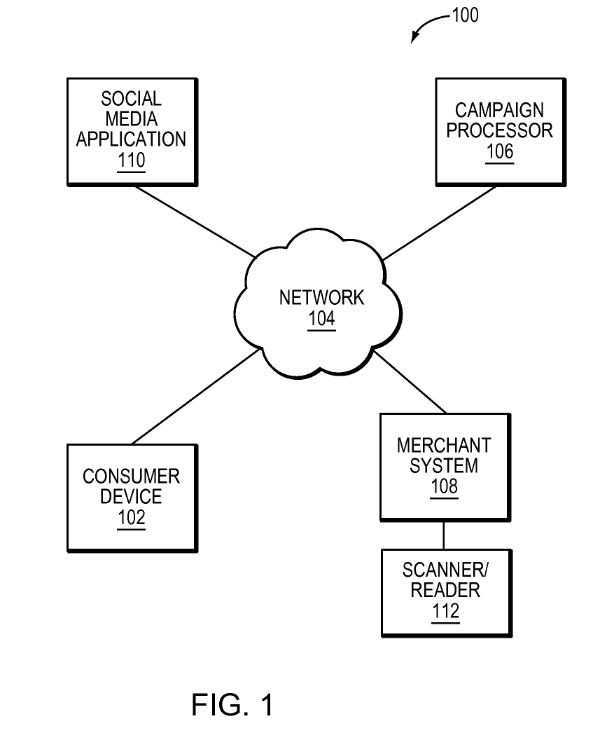

Refer first to FIG. 1, which depicts an exemplary promotional-campaign network 100 including a consumer device (e.g., a mobile device) 102 linked to other systems via a network 104 that supports wired, wireless, or any two-way communication (e.g., a cellular telephone network, the Internet, or any wide-area network or combination of networks capable of supporting point-to-point data transfer and communication). The network 104 connects various devices, including a campaign processor 106, one or more merchant systems 108, and one or more servers hosting social media applications 110 utilizing, again, wired, wireless, or any suitable form of two-way communication. In response to a request to begin a new promotional campaign to attract a target number of consumers and fill rate, the campaign processor 106 distributes an initial batch of an electronically claimable and redeemable promotional offer to mobile devices 102, email accounts, or social media accounts associated with consumers known to the campaign processor 106 by virtue of prior activity, e.g., a purchase history with the merchant responsible for the new promotional campaign. The processor 106 tracks the status of the distributed offer, recording, for example, claims, redemptions, elapsed time between receipts, claims, and redemptions, and modes of distribution to be used for assessing a predicted fill rate. The predicted fill rate is continuously, or periodically, calculated and the offer is distributed to additional consumers until the targeted fill rate is achieved. Any number of merchant systems may communicate over the network 104, but for present purposes, the merchant system 108 is operated by the merchant initiating the promotional campaign or is within the network of merchants that sell goods or services relevant to the campaign offer. In one embodiment, the merchant system 108 is a point-of-sale (POS) system that connects to a code reader or scanner (hereafter “reader”) 112. The reader 112 may be mobile or physically associated with the merchant system 108 and may be capable of reading and/or decoding a promotional offer presented by a consumer on her mobile device 102, in the form of, for example, a barcode, a radio frequency identification (RFID) code, or a QR code, and/or receiving signals, such as NFC signals, acoustic signals, or infrared signals. The merchant system 108 is responsible for applying a discount to goods or services purchased by the consumer based on information provided therein.

The social-media application(s) 110 may be a collaborative project (e.g., WIKIPEDIA), blog or microblog (e.g., TWITTER and PINTEREST), content community (e.g., YOUTUBE), social networking site (e.g., FACEBOOK and GOOGLE+), or any one, or combination of, network-based application that allows the creation and/or exchange of user-generated content, such as an electronic promotional offer.

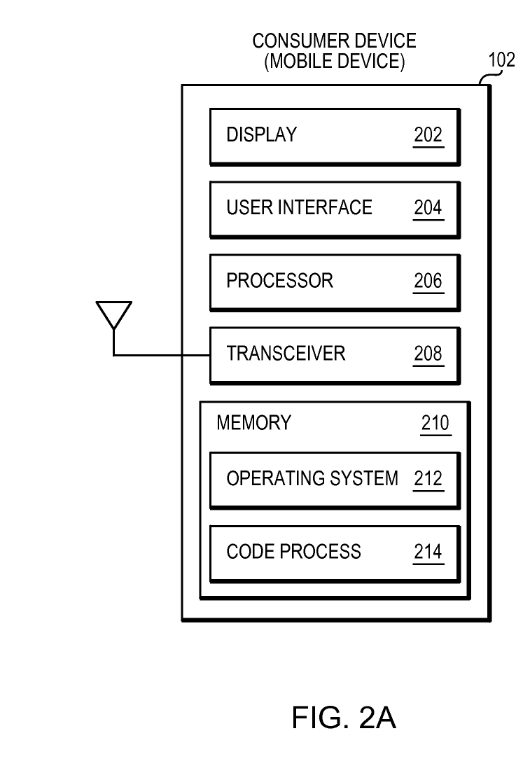

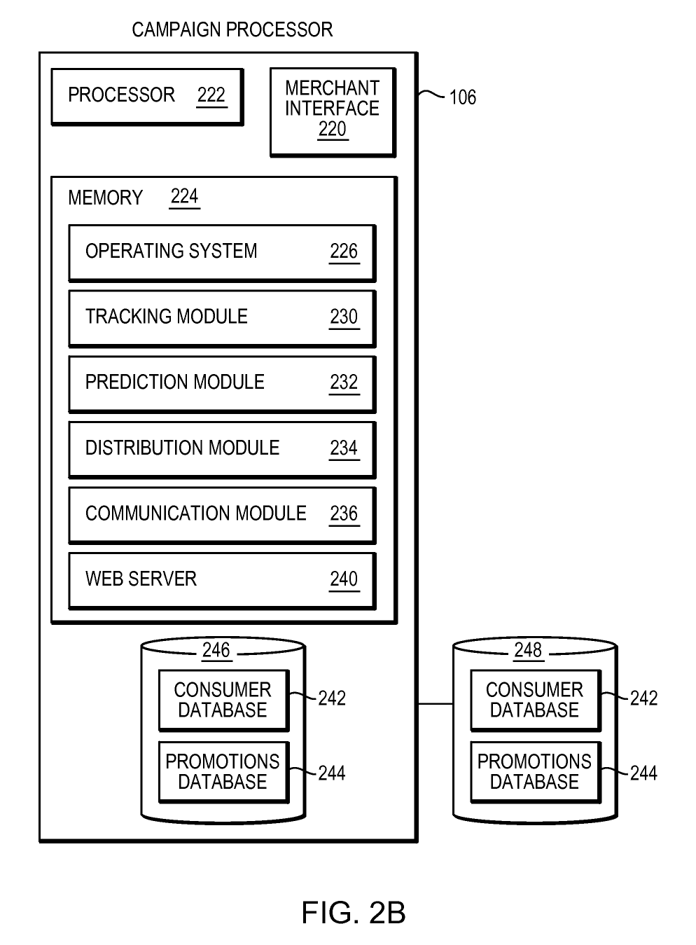

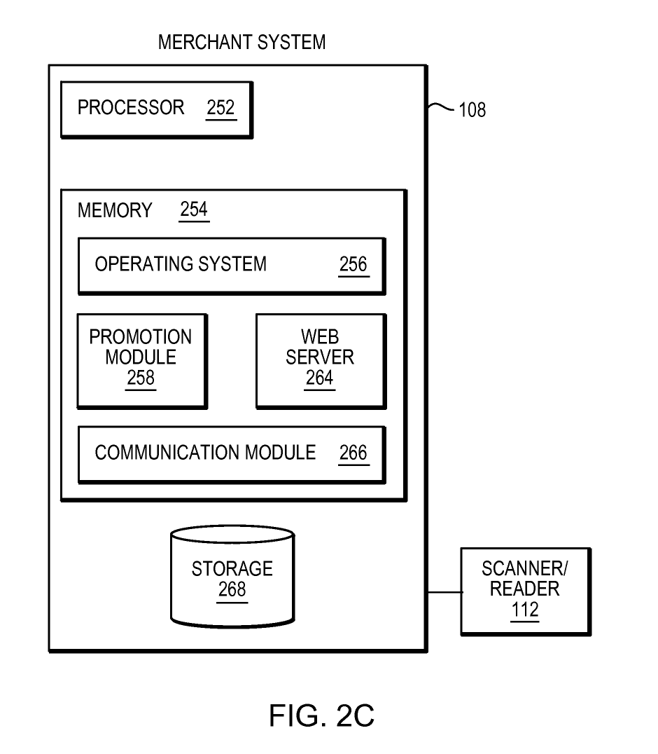

The mobile device 102 acts as a gateway for transmitting the consumer's data to the network 104. The mobile device 102 can support multiple communication channels for exchanging multimedia and other data with the server 106 and other devices using a Wi-Fi LAN (e.g., IEEE 802.11 standard) for Internet access, a short-range Bluetooth wireless connection for point-to-point access, and/or an NFC channel for close-proximity access. The mobile device 102 is the preferred means in which the consumer will redeem a promotional offer with the merchant system 108. This is accomplished by downloading an application (“app”) capable of accessing the consumer's account within the campaign processor 106 to retrieve and display any offer that the consumer may have previously claimed. In one embodiment, the consumer may also claim promotional offers distributed directly to her mobile device 102 from the campaign processor 106 via the downloaded app. Referring to FIG. 2A, in various embodiments, the mobile device 102 includes a conventional display screen 202, a user interface 204, a processor 206, a transceiver 208, and a memory 210. The transceiver 208 may be a conventional component (e.g., a network interface or transceiver) designed to provide communications with a network, such as the Internet and/or any other land-based or wireless telecommunications network or system, and, through the network, with the campaign processor 106. The memory 210 includes an operating system (OS) 212, such as GOOGLE ANDROID, NOKIA SYMBIAN, BLACKBERRY RIM or MICROSOFT WINDOWS MOBILE, and a code process 214 that implements the device-side functions as further described below. Additional transactional information may be embedded in the code process 214 for transmission through the network 104 for later processing on a back-end server (e.g., the campaign processor 106). As used herein, the term “mobile device” used for claiming and redeeming a promotional offer refers to a “smart phone” or tablet with advanced computing ability that, generally, facilitates bi-directional communication and data transfer using a mobile telecommunication network, and is capable of executing locally stored applications and/or promotional offers. Mobile devices include, for example, IPHONES (available from Apple Inc., Cupertino, Calif.), BLACKBERRY devices (available from Research in Motion, Waterloo, Ontario, Canada), or any smart phones equipped with the ANDROID platform (available from Google Inc., Mountain View, Calif.), tablets, such as the IPAD and KINDLE FIRE, and personal digital assistants (PDAs). The memory 210 may include computer storage media in the form of volatile and/or nonvolatile memory such as read only memory (ROM) and random access memory (RAM). A basic input/output system (BIOS), containing the basic routines that help to transfer information between elements, such as during start-up, is typically stored in ROM. RAM typically contains data and/or program modules that are immediately accessible to and/or presently being operated on by processing unit.

The campaign processor 106 is a trusted system that organizes a promotional campaign and, in particular, allows the organizer to target a specific number of consumers and fill rate over a set period of time. The campaign processor 106 may be implemented as a running process on a stand-alone computer or can be integrated, in some embodiments, with a merchant system 108. The processor 106 dynamically distributes and tracks a promotional offer, adjusting distribution and availability to target a specific fill rate (e.g., 100%). FIG. 2B shows in greater detail the functional components of the campaign processor 106 including, in various embodiments, a merchant interface 220 configured to receive promotional campaign specifications and updates from the merchant or merchant system 108. The merchant interface 220 may be any form of application programming interface (API), such as a website, enabling communication via network 104 between the merchant system 108 and the campaign processor 106—in particular, allowing a merchant to log in and define a new promotional campaign. Additionally, in various embodiments, the campaign processor 106 includes a processor 222 and a memory 224, which may include volatile and non-volatile portions. The memory 224 contains instructions, conceptually illustrated as a group of modules, that control the operation of the processor 222 and its interaction with hardware components. An operating system 226 directs the execution of low-level, basic system functions such as memory allocation, file management and operation of mass storage devices. At a higher level a tracking module 230, a prediction module 232, a distribution module 234, a communication module 236, and a web server block 240 perform the critical functions associated with embodiments of the present invention. The communication module 236 may be a conventional component (e.g., a network interface or transceiver) designed to provide communications with a network, such as the Internet and/or any other land-based or wireless telecommunications network or system, and, through the network, with the mobile device 102, the merchant system 108, and the social media application 110. The web-server block 240 enables web-based communication with the mobile device 102 and the social media application 110, and can be a conventional web-server application executed by the processor 222. Additionally, the web-server block 240 may interact with any of a variety of public APIs provided by social media applications; via these APIs, third-party applications collect data available from the social media application 110 in order to retrieve relevant tracking data about promotional offers distributed to social media accounts. A consumer database 242 and a promotions database 244 may reside in a storage device 246 and/or an external mass-storage device 248 accessible to the campaign processor 106. The consumer database 242 stores, for example, a record associated with each consumer “known” to the campaign processor 106 by virtue of participation in prior campaigns or due to prior purchases from the merchant responsible for the campaign (assuming the merchant has made this data available to the campaign processor 106). In some embodiments, the database 242 stores data identifying the consumer's mobile device 102, with associated account information (e.g., username/password combination). The promotions database 244 stores information associated with each promotion, including a record of each distributed, claimed and redeemed offer cross-referenced to the associated consumer in the consumer database 242. The databases 242, 244 are responsive to queries from the tracking module 230, the prediction module 232, and the distribution module 234.

In typical operation, a merchant accesses the campaign processor 106 by logging into the merchant interface 220, which typically requires conventional authentication and sign-in. Although the campaign-processor system 106 may be integrated with the merchant system 108 or otherwise operated entirely by the merchant, as noted above, in typical implementations the system 106 is implemented at a server accessible to multiple merchants via, for example, the Internet; in such implementations, the server maintains a separate logical or physical promotions database 244 for each participating merchant and, via web interaction with the server and pages personalized to the merchant, the merchant experiences use of the system 106 as if implemented on a merchant-controlled computer. Upon logging in, the merchant is prompted to choose from a menu of options including pre-defined offers (e.g., a discount applied to a total sale amount) saved as templates in the promotions database 244. Alternatively, the merchant may wish to define a new offer (e.g., a discount on a specific item); the merchant interface 220 guides the merchant through the steps of defining the offer, the terms of which are then saved to the promotions database 244. After the promotional offer has been defined, the merchant is prompted to enter the length of time for which to run the campaign, the target number of consumers he wishes to attract (i.e., the target number of redemptions), and a target fill rate. As described above, the target fill rate is the percentage of the desired redemptions that should be targeted. Alternatively, in one embodiment, a default target fill rate of 100 percent is used. The target criteria supplied by the merchant is saved to the promotions database 244 effectively starting the campaign process. In the first step of the campaign, the distribution module 234 queries to the consumer database 242 for an initial group of consumers to receive the promotional offer. The consumers may be chosen at random by the distribution module 234 from the consumer database 242. Alternatively, the merchant may wish to target consumers who fit key demographic and/or psychographic criteria that imply predisposition toward his products. Identification and distribution of promotion offers to target consumers may be performed using systems and methods described in co-pending application Ser. No. ______, filed on even date herewith and entitled SECURE SYNCHRONIZATION OF PAYMENT ACCOUNTS TO THIRD-PARTY APPLICATIONS OR WEBSITES, the entirety of which is hereby incorporated by reference. In one embodiment, the number of consumers in the initial distribution group is equal to the target number of redemptions. It may, however, be safe to assume that not all of the consumers will redeem, or even claim, the offer distributed to them. Accordingly, in one embodiment, the number of consumers in the initial distribution group may greater than the target redemption number. The promotional offer is distributed electronically via a preferred modality (e.g., mobile device) to the identified consumers and a record of each consumer receiving the offer is saved to the promotions database 244. The status of each distributed offer being electronically trackable by the tracking module 230 through the merchant interface 220, the communication module 236, or the web server 240.

The consumer may claim the offer by selecting, or clicking, on a claim option included in the distributed offer which triggers a signal to be sent to the tracking module 230. A record of the claimed offer is saved to the consumer's account for her to access for redemption at a later time. The tracking module 230 is also responsible for updating the promotions database 244 each time that the offer is claimed, recording, for example, a timestamp and a consumer identifier on each occurrence. Once claimed, the consumer may redeem the offer for the discount included therein by presenting it on her mobile device 102 to the merchant offering the promotion. In one embodiment, the campaign processor 106 may receive notification that the consumer has claimed the offer from the merchant system 108 wherein the tracking module 230 updates the promotions database 244 with a record of the transaction accordingly. Alternatively, the promotional offer or application on the mobile device 102 may be encoded to trigger, at the time of redemption, the device 102 to transmit notification of the transaction directly to processor 106; the tracking module 230 then updating the promotions database 244 accordingly.

The prediction module 232 is responsible for analyzing the distribution, claim, and redemption records for the current promotion in the promotions database 244 to determine a current and predicted fill rate. In one embodiment, the prediction module 232 may re-calculate the predicated fill rate each time the offer is distributed, claimed or redeemed. Alternatively, the prediction module 232 may be configured to calculate the predicated fill rate periodically (such as, once a day) to conserve resources. The predicated fill rate may be based on a claim to redemption ratio, a calculated viral spread, a determined likelihood of redemption, or any combination thereof as is described in further detail below. The distribution module 234 continues to distribute the promotional offer to additional groups of consumers until the predicted fill rate equals the target fill rate. Once this occurs distribution is suspended but the tracking module 230 and prediction module 232 continue to operate as the predicted rate is likely to fall as time passes and more distributed offers are determined to be unlikely to be claimed. When or if this occurs, additional offers will be distributed. The campaign processor 206 continues to run the campaign until one of two events occurs: the actual fill rate equals the target fill rate or the campaign has run for the maximum length of time allowed by the merchant.

Referring to FIG. 2C, in various embodiments, the merchant system 108 includes a processor 252, a memory 254, an operating system 256, a promotion module 258, a web server block 264, a communication module 266, and a storage device 268. As described above, the various functional modules are typically implemented as stored instructions that operate as running processes via the processor 252. The merchant system 108 may be connected to or include the reader 112, which is capable of reading presented promotion offers according to any suitable modality (optical, NFC, etc.) from a consumer's mobile device 102. The promotion module 258 is responsible for verifying that the promotional offer presented is valid for her current purchase and if so, applying the appropriate discount to the purchase as indicated in the information obtained by the reader 112. In one embodiment, the promotion module 258 is further configured to transmit a record of the transaction to the campaign processor 106.

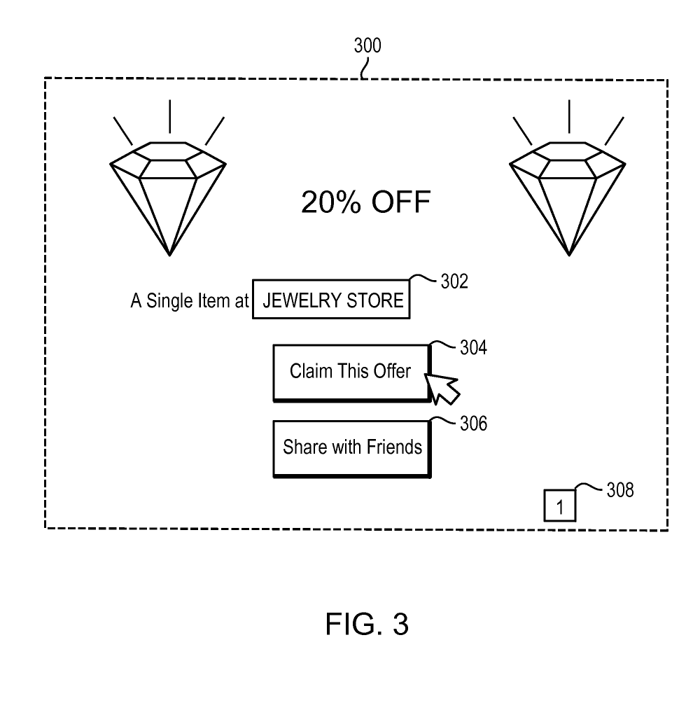

FIG. 3 illustrates an example of a promotional offer 300 offered by merchant (identified at 302) that may be distributed to a social media account, an email account, or a mobile device of a consumer whose contact information is stored in, or accessible to, the campaign processor 106 as described in greater detail below. The promotional offer 300 may be distributed to a single consumer or to a group of consumers. The offer 300 may include a claim link (“button”) 304 and, in some embodiments, a share link (“button”) 306. The consumer may claim the offer simply by selecting the claim button 304. Alternatively or in addition, the consumer can share the offer with a friend by selecting the share button 306, which will provide her with options to share the promotion electronically.

The claim link 304 is encoded, upon selection, to prompt the consumer to log in to her account, or create an account, with campaign processor 106 before the offer may be claimed. This results in creation of a record for the consumer in the consumer database 242, enabling the campaign processor 106 to target future offers to the consumer. With reference to FIGS. 1 and 2B, upon successful login, or account setup, a record of the claimed offer may be saved to the consumer's record in the consumer database 242; currently active offers may be made available for the consumer to display (via a downloaded “app”) on her mobile device 102, and the record facilitates the consumer's redemption of the offer with the merchant 302. Additionally, a record of the claim may be saved to promotions database 244 for subsequent analysis in determining the predicted fill rate. A consumer not having an existing account with the processor 106 may click on the claim link 304, but decide not to create an account and, in some embodiments, this event may be recorded to the promotions database 244 as a “missed opportunity” to be used for subsequent analysis in determining the predicted fill rate.

In one embodiment, the share link 304 is operative, upon selection, to provide the consumer with a link to the offer 300 to share via email or social media. Alternatively, the share link 304 may cause display of a dialog box prompting the consumer to choose the media application by which to share the offer 300 and contact information for the individual or individuals with whom the offer will be shared. The consumer may, for example, be offered the options of sharing via email, via social media application 110, or to another consumer's account within the campaign processor 106. In one embodiment, the tracking module 230 is configured to create a record in the promotions database 244 each time a link to the offer 300 is requested, counting this as an additional distributed offer. Additionally, records of shared promotions may be used in determining in the predicted fill rate, and in particular, the viral spread.

Each promotional offer 300 distributed to a plurality of consumers may have a unique identifier 308 associated with it. The identifier 308 may physically appear on the offer, as is illustrated, and/or it may be encoded within the electronic offer data; the identifier may be recorded by the tracking module 230 in the promotions database 244 when the offer is distributed, claimed, or redeemed. This identifier may additionally aid in tracking the promotional offer 300 to be used in subsequent analysis, particularly when determining viral spread. For example, if the offer with a unique identifier number one is transmitted to one potential consumer but 10 claims are recorded for offer number one, a high rate of viral spread may be assumed, and more claims and redemptions are expected from this particular distributed promotion. Conversely, the same promotional offer with unique identifier number two may have been transmitted in the same batch as offer number one but no claims are recorded, in which case the offer is considered to have a low viral spread (and no additional claims are redemptions are expected).

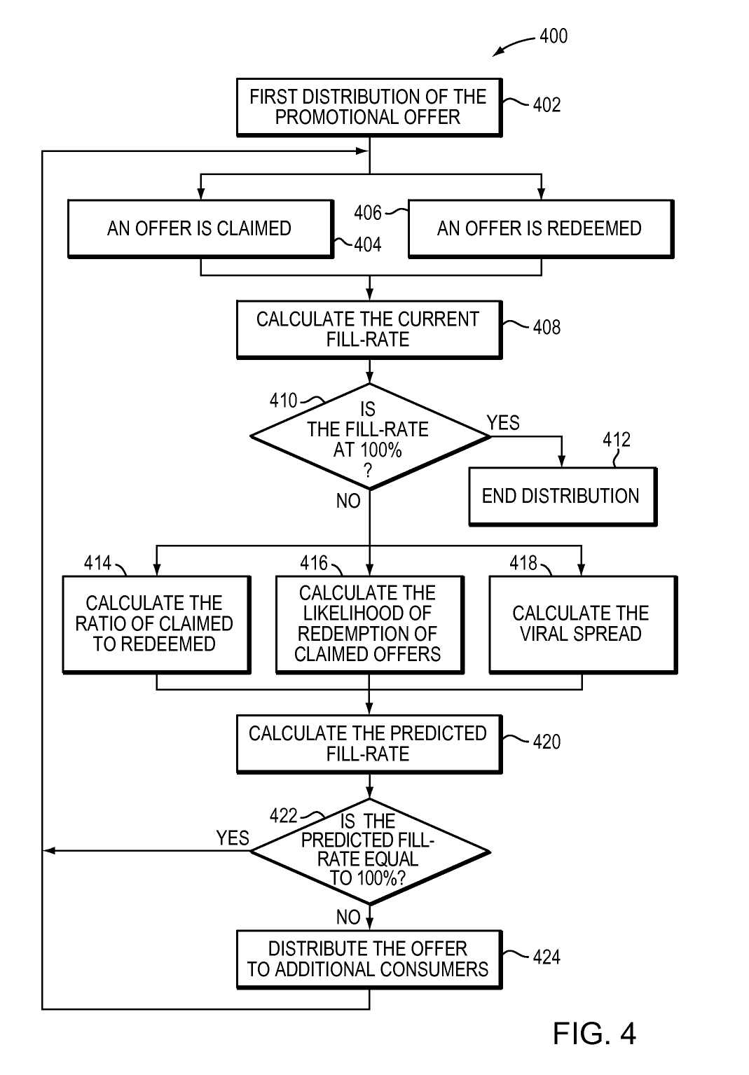

FIG. 4 illustrates an exemplary method 400 of organizing an electronic promotional campaign in accordance with one embodiment of the current invention. A merchant decides to run a promotional campaign (for example, merchandise or services offered at a discount to new consumers) over a set period of time to target a specific number of consumers and a specific fill rate as described above. With reference to FIGS. 1-4, the number of distributions and claims the campaign processor 106 should allow in order to achieve the target fill rate, ideally without overshooting, is continuously or periodically calculated after the offer is distributed to a first group of consumers. The first group of consumers may be targeted based on some prior history suggestive of success, e.g., prior purchases of similar goods from the merchant or prior history (in the consumer's record in the consumer database 242) of claiming and redeeming offers distributed by the campaign processor 106.

The ad campaign may be distributed by the distribution module 234 to a social media account, an email account, or a mobile application of a consumer having an account with the campaign processor 106 (step 402). The transmitted offer may include links to claim and/or to share/post the offer via email, social media, or mobile application, making it visible to (and ultimately claimable by) others. As previously described, the promotional offer has a link 304 for the consumer to claim the offer. Upon claiming the offer, the consumer is prompted to sign into her account or create an account with the campaign processor 106 if she does not already have one. The consumer may set up an account by providing, for example, an email address and password combination. Following successful login or account setup, the claimed offer is added to the consumer's account along with, in some embodiments, an associated expiration date (step 404). Additionally, a record of the claim is also saved by the tracking module 230 to the promotions database 244. In some instances, the consumer may not wish to provide the information required to create an account, making her ineligible to claim the offer but, in some embodiments, this occurrence is saved to the promotions database 244 as a “missed opportunity” to be used in the analysis performed by the prediction module 232, such as in viral spread calculations.

The consumer may redeem the promotional offer by presenting it upon check-out with the merchant system 108. In one embodiment, the consumer logs in to an app (previously downloaded) on her mobile device 102 to display the claimed offer in the form of, for example, a QR code, NFC signal, or any other appropriate format readable by the scanner 112. Alternatively, the consumer may log in to her account to retrieve and print, prior to check-out, a copy of the claimed offer including a barcode or other identifier to present to the merchant for redemption. The scanner 112 of merchant system 108 may be configured to decode the presented offer before transmitting it to the merchant system 108. The promotion module 258 may verify that the offer is valid, apply a discount as indicated in the decoded information, and transmit a record of the redeemed offer (including a consumer identifier) to the campaign processor 106 (step 406). In one embodiment, the merchant system 108 is configured to add the consumer identifier to promotion data before transmission; alternatively, the consumer identifier may already be encoded into the offer data decoded by the scanner 112. In either case, the record is received by the tracking module 230 of the campaign processor 106 and the promotions database 244 is updated accordingly. In another embodiment, the application on the mobile device 102 used to present the offer is configured to transmit, at the time of redemption, a signal notifying the processor 106 of the transaction; the tracking module 230 updates the promotions database 244 accordingly.

Upon each occurrence of a claim or redemption of the promotional offer, the prediction module 232 may calculate a current fill rate (step 408). Alternatively, the current fill rate may be calculated according to a predefined schedule (e.g., once a day). The current fill rate is determined by comparing the current number of redemptions to the target number of redemptions for the relevant time during the promotion period. The prediction module 232 then evaluates if the current fill rate has reached the targeted fill rate (step 410). If the current fill rate is at, or near, the targeted fill rate, the prediction module 232 sends a signal to the distribution module 234 to stop distributing, or making available, the promotional offer to be claimed (step 412). In one embodiment, stopping distribution may include discontinuing, or invalidating, the link for consumers to claim any offer that has already been distributed and not yet claimed. Conversely, if the current fill rate is below the targeted fill rate, additional data is analyzed by the prediction module 232 and used to determine if the offer should be distributed to additional consumers and, in some embodiments, how the offer should be distributed.

The act of claiming an offer by the consumer merely indicates that he is considering redeeming the offer; more granular prediction is desirable to estimate the predicted fill rate and determine how many, if any, additional offers should be distributed. Just as every distributed offer may not be claimed, every claimed offer may not be redeemed. One way that the prediction module 232 may determine the predicted fill rate is to calculate and analyze the current ratio of claims to redemptions (step 414). For example, a claim-to-redemption ratio of one means that all claimed offers have been redeemed and that no additional redemptions are expected (assuming the offer has not been shared among consumers). However, more likely scenarios will have a much lower claim-to-redemption ratio. The prediction module 232 may use a reference ratio, such as a final claim-to-redemption ratio from a completed campaign, to calculate the expected redemptions of outstanding offers that have been claimed but not redeemed. For example, if the current campaign is a “buy one get one free” (BOGO) promotion, the average claim to redemption ratio of completed BOGO campaigns may be used as the reference ratio; if multiple reference ratios for BOGO offers are available, the one obtained for the campaign having attributes (in terms type of goods, geographic area, etc.) closest to those of the present campaign may be utilized. If, on average, in past campaigns half of the consumers who claimed an offer ultimately redeemed the offer (i.e., a ratio of two), and the current claim-to-redemption ratio is four, the prediction module 232 may be estimate, for example, that for every three of the currently claimed offers one more redemption is expected.

The reference claim-to-redemption ratio may also be time-dependent, i.e., be tagged with the time during the reference offering that the ratio was established. For example, the claim-to-redemption ratio may be higher in the beginning of a campaign than later. By consulting a reference ratio that has been adjusted for elapsed time, a more accurate fill rate prediction may be obtained at a particular point in the current campaign.

In addition to analyzing the ratio of claimed to redeemed offers, other parameters may be employed to calculate the likelihood that particular claimed offers will be redeemed (step 416); this allows the fill rate to be predicted with greater accuracy by refining redemption likelihoods associated with currently outstanding offers. In one embodiment, the likelihood of a consumer redeeming an offer that he has claimed, but not redeemed, is based on the amount of time that has elapsed since the offer was claimed. For example, as the elapsed time increases, the likelihood of redemptions decreases, and the relationship between elapsed time and redemption likelihood can be determined empirically (e.g., as a function of time since redemption). Reminders may be sent to a consumer who has claimed, but not redeemed the offer in order to gauge the likelihood of redemption. For example, if no reminders have been sent to the consumer, she might be assigned a high likelihood of redeeming the offer. However, if she has received multiple reminders and still has not redeemed the offer, she is assigned a low likelihood of redeeming the offer, and one or more additional offer may be given away in its place.

In one embodiment, the distributed promotional offer is shared electronically among consumers and the viral spread (i.e., the rate at which it is being shared) is used in computing the predicted fill rate (step 418). Various factors may contribute to the viral spread. One such factor is the distribution mechanism. For example, the viral spread of an offer distributed to individual mobile devices 102 may be considerably lower than that of an offer posted on a social media site. Additionally, the viral spread may also be calculated based in part on information obtained by the tracking module 230. The rate at which the offer is claimed by consumers to whom the promotional offer was not directly sent may be analyzed to determine the rate of consumer referral and, hence, the number of offers effectively outstanding at a given time. In some cases, for example, the percentage of offers claimed relative to offers sent may exceed 100%, indicating a high rate of viral spread and/or a high redemption rate; the faster the offer is determined to be spreading, the lower will be the number of additional offers needed to reach the target fill rate. In some embodiments, the distributed promotional offer includes a unique identifier that is used to track the rate of viral spread. Any one method described above, or any combination thereof, may be employed when determining the predicted fill rate.

The predicted number of redemptions is compared to the target redemption number to arrive at the predicted fill rate (step 420). The predicted fill rate is computed (step 422) (and as noted above, this computation may depend in part on the time elapsed since initiation of the offer) and distribution of the promotional offer to additional consumers is continued (step 424) until the predicted fill rate equals the target fill rate. At this time, distribution is suspended but the tracking module 230 and prediction module 232 continue to operate, periodically monitoring the fill rate and adjusting distribution of the promotion as the actual rate deviates from the predicted rate; for example, the actual rate is likely to fall as time passes and more distributed offers are determined to be unlikely to be claimed. The campaign processor 206 continues to run the campaign until one of two events occurs: the actual fill rate reaches the target fill rate (step 412) or the campaign has run for the maximum length of time allowed by the merchant.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. For example, each of the processors described herein may be a general-purpose computer, but alternatively may be a CSIC (consumer-specific integrated circuit), ASIC (application-specific integrated circuit), a logic circuit, a digital signal processor, a programmable logic device, such as an FPGA (field-programmable gate array), PLD (programmable logic device), PLA (programmable logic array), RFID processor, smart chip, or any other device or arrangement of devices that is capable of implementing the steps of the processes of the invention.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The various modules and apps described herein can include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. Accordingly, the described embodiments are to be considered in all respects as only illustrative and not restrictive.

What is claimed is:

1. A computer-implemented method of operating a promotional campaign to dynamically target a specific fill rate, the method comprising:
electronically distributing to a first group of consumers a promotional offer claimable and redeemable via an electronic device; and
using a computer to, automatically:
(i) track claims and redemptions of the offer by the consumers;
(ii) computationally determine a current fill rate at a current time based at least in part on the tracking, the current fill rate corresponding to a number of redemptions of the offer;
(iii) computationally determine a predicted fill rate at a future time for the first group of consumers, the predicted fill rate being based on the current fill rate and at least one prediction factor; and
(iv) cause electronic distribution of the promotional offer to a second group of consumers only if the predicted fill rate for the first group of consumers is less than the target fill rate, the second group of consumers having a size dependent on (i) a difference between the current fill rate and the target fill rate and (ii) a predicted fill rate for the second group of consumers.

2. The method of claim 1, wherein the predicted fill rate is based at least in part on a ratio of claimed offers to redeemed offers and a reference ratio of claimed offers to redeemed offers.

3. The method of claim 1, wherein the predicted fill rate is based at least in part on calculated likelihoods of redemption of the claimed offers.

4. The method of claim 3, wherein the likelihood of redemption is based at least in part on an amount of time that has elapsed since the consumer has claimed the promotional offer.

5. The method of claim 3, further comprising sending reminders to consumers who claimed the promotional offer, wherein calculating the likelihoods of redemption is based at least in part on a number of reminders that have been sent.

6. The method of claim 1, wherein the predicted fill rate is based at least in part on a viral spread of the offer.

7. The method of claim 6, wherein the offer is trackably sharable and the viral spread is based at least in part on tracked sharing of the offer.

8. The method of claim 1, wherein the current predicted fill rate is determined based at least in part on an elapsed time since initiation of the campaign.

9. A system for managing a promotional campaign to dynamically target a specific fill rate, the system comprising:
(a) a promotions database for storing records each comprising (i) an identifier of a consumer to whom the offer has been sent and (ii) a status field indicating whether the consumer has claimed or redeemed the promotional offer; and
(b) a processor for executing, automatically:
(i) a tracking module for updating the promotions database each time a consumer claims the promotional offer and for updating the promotions database each time a consumer redeems the promotional offer;
(ii) a prediction module for calculating (A) a current fill rate at a current time based at least in part on the data in the promotions database, the current fill rate corresponding to a number of redemptions of the offer, and (B) a predicted fill rate at a future time, the predicted fill rate being based on the current fill rate and at least one prediction factor; and
(iii) a distribution module for distributing the promotional offer to a first group of consumers and, thereafter, to a second group of consumers only if a predicted fill rate for the first group of consumers is less than the target fill rate, the second group of consumers having a size dependent on (A) a difference between the current fill rate and the target fill rate and (B) a predicted fill rate for the second group of consumers.

10. The system of claim 9, wherein the predicted fill rate is based at least in part on a ratio of claimed offers to redeemed offers and a reference ratio of claimed offers to redeemed offers.

11. The system of claim 9, wherein the predicted fill rate is based at least in part on likelihoods of redemption of the claimed offers calculated by the prediction module.

12. The system of claim 11, wherein the likelihood of redemption is based at least in part on an amount of time that has elapsed since the consumer has claimed the promotional offer.

13. The system of claim 11, wherein the distribution module is further configured to send reminders to consumers who claimed the promotional offer, wherein the prediction module is configured to calculate the likelihoods of redemption based at least in part on a number of reminders that have been sent.

14. The system of claim 9, wherein the prediction module is further configured to compute a viral spread of the offer.

15. The system of claim 14, wherein the promotional offer is trackably sharable.
